(19) United States
(12) Patent Application Publication
(10) Pub. No.: US 2015/0231652 A1
(43) Pub. Date: Aug. 20, 2015

(54) GROUNDING RODS FOR ELECTROSTATIC SPRAY

(71) Applicant: GRACO MINNESOTA, INC., Minneapolis,, MN (US)

(72) Inventor: Mark E. Ulrich, Oak Grove, MN (US)

(21) Appl. No.: 14/432,684

(22) PCT Filed: Sep. 30, 2013
(86) PCT No.: PCT/US2013/062677

§ 371 Date: Mar. 31, 2015

Related U.S. Application Data
(60) Provisional application No. 61/708,148, filed on Oct. 1, 2012.

(51) Int. Cl. B05B 5/03; B05B 5/053

(52) U.S. Cl. CPC B05B 5/03; B05B 5/0533; B05B 5/0532

(57) ABSTRACT

An electrostatic spray gun comprises a gun barrel, a housing attached to the gun barrel, a spray tip assembly attached to the barrel opposite the housing, and a first grounding rod. The spray tip assembly is situated at one end of the gun barrel, and has an electrode extending away from the gun barrel. The first grounding rod is electrically connected to the housing but electrically separated from the spray tip assembly, and extends along the gun barrel from the housing towards the spray tip assembly.

### BACKGROUND

The present invention relates generally to applicators that are used to spray fluids, such as paint, sealants, coatings, enamels, adhesives, powders and the like. More particularly, the invention relates to electrostatic spray guns.

In electrostatic spray systems, an electrostatic field is produced in the vicinity between the spray gun and the target or article to be sprayed. The sprayed particles are propagated through this field, and the respective particles pick up electrical charges as they pass through the field. The charged particles are thereby attracted to the article to be sprayed. By this process, it is possible to direct a much higher percentage of sprayed particles to the actual article to be sprayed, and thereby the efficiency of spraying is vastly improved over conventional methods. Electrostatic spray guns are particularly useful for applying non-conductive liquids and powders, although they may be used in connection with spraying conductive liquids.

In a typical electrostatic spraying system, an ionizing electrode is placed in the vicinity of the spray gun spray orifice, the article to be painted is held at ground potential, and an electrostatic field is developed between the ionizing electrode and the article. The distance between the electrode and ground may be on the order of about 0.5 meters or less; therefore, the voltage applied to the spray gun electrode must necessarily be quite high in order to develop an electrostatic field of sufficient intensity to create a large number of ion/particle interactions so as to develop a sufficient attractive force between the paint particles and the target. It is not unusual to apply electrostatic voltages on the order of 20,000-100,000 volts (20-100 kV) to the spray gun electrode in order to achieve a proper degree of efficiency in the spraying operation. An ionizing current on the order of 50 micro-amps typically flows from the spray gun electrode.

Electrostatic spray guns may be hand-held spray guns or automatic spray guns operable by remote control connections. The sprayed fluid may be atomized using different primary atomizing forces, such as pressurized air, hydraulic forces, or centrifugal forces. Power for the electrostatic voltage may be generated in a variety of ways. In many systems, an external power source is connected to the electrostatic spray gun. However, in other designs, power may be generated with an alternator located in the electrostatic spray gun. For example, U.S. Pat. Nos. 4,554,622, 4,462,061, 4,290,091, 4,377,838, 4,491,276 and 7,226,004 describe electrostatic spray guns having an air-powered turbine which drives an alternator that in turn supplies a voltage multiplier to provide the charging voltage.

### SUMMARY

An electrostatic spray gun comprises a gun barrel, a housing attached to the gun barrel, a spray tip assembly attached to the barrel opposite the housing, and a first grounding rod. The spray tip assembly is situated at one end of the gun barrel, and has an electrode extending away from the gun barrel. The first grounding rod is electrically connected to the housing but electrically separated from the spray tip assembly, and extends along the gun barrel from the housing towards the spray tip assembly.

### BRIEF DESCRIPTION OF THE DRAWINGS

FIG. 1 is a schematic of an electrostatic spray system showing an electrostatic spray gun connected to a fluid supply and discharging onto a target.

FIG. 2 is a perspective view of the electrostatic spray gun of FIG. 1 showing a gun barrel connected to a handle body and a spray tip assembly.

FIG. 3 is an exploded view of the electrostatic spray gun of FIG. 2 showing an alternator and a power supply configured to be located within the gun barrel.

FIG. 4 is a perspective view of the electrostatic spray gun of FIGS. 1-3, showing a grounding rod embedded in the gun barrel.

FIG. 5 is a cross-sectional view of the gun barrel of the electrostatic spray gun of FIG. 4, showing two grounding rods.

### DETAILED DESCRIPTION

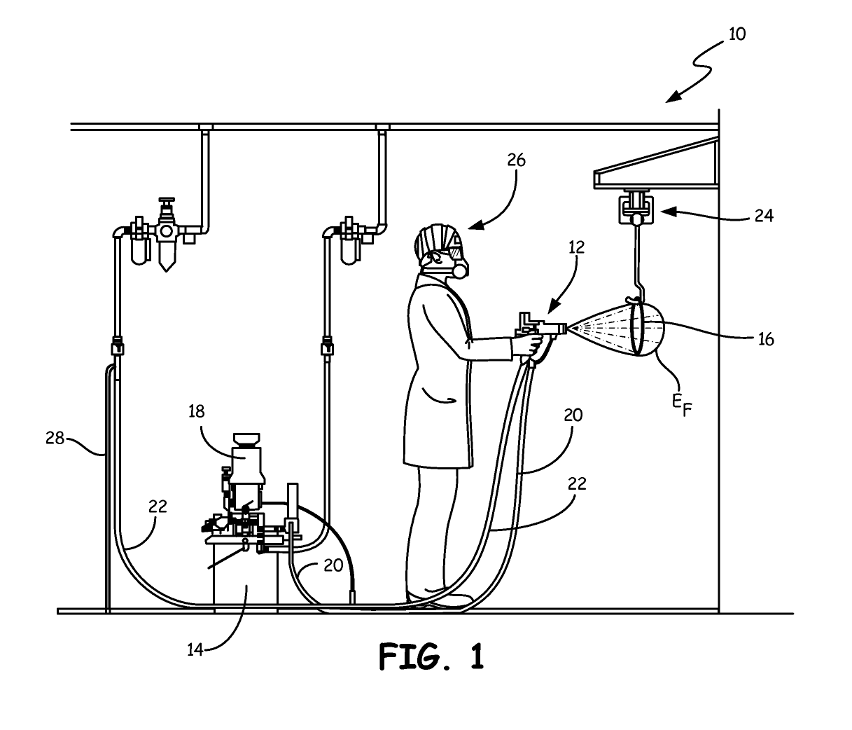

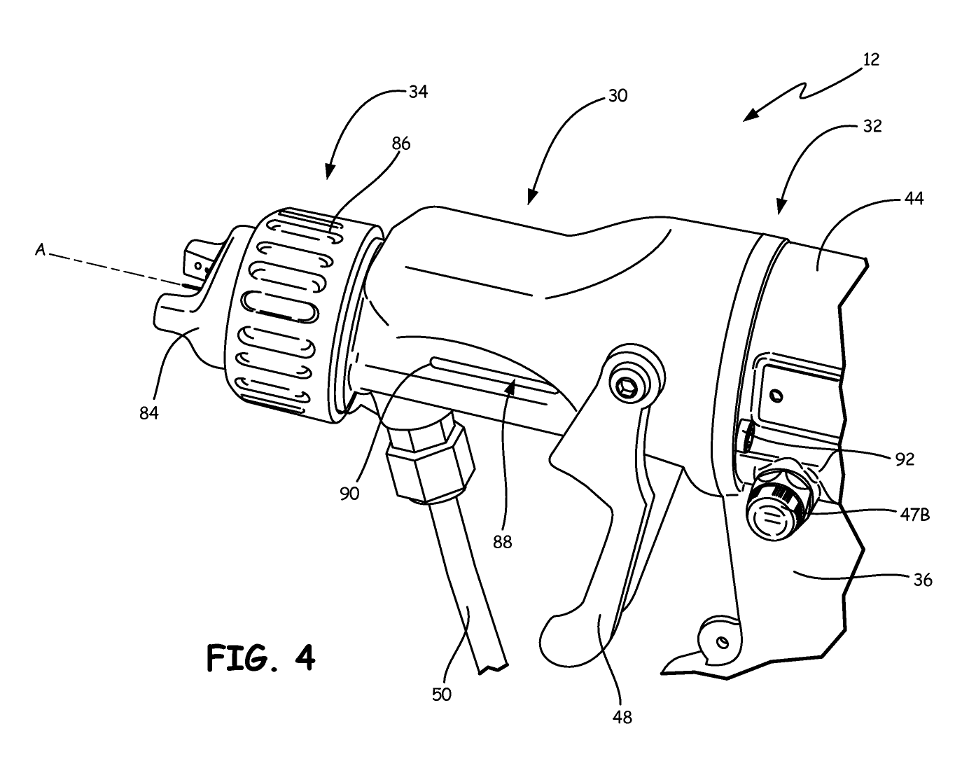

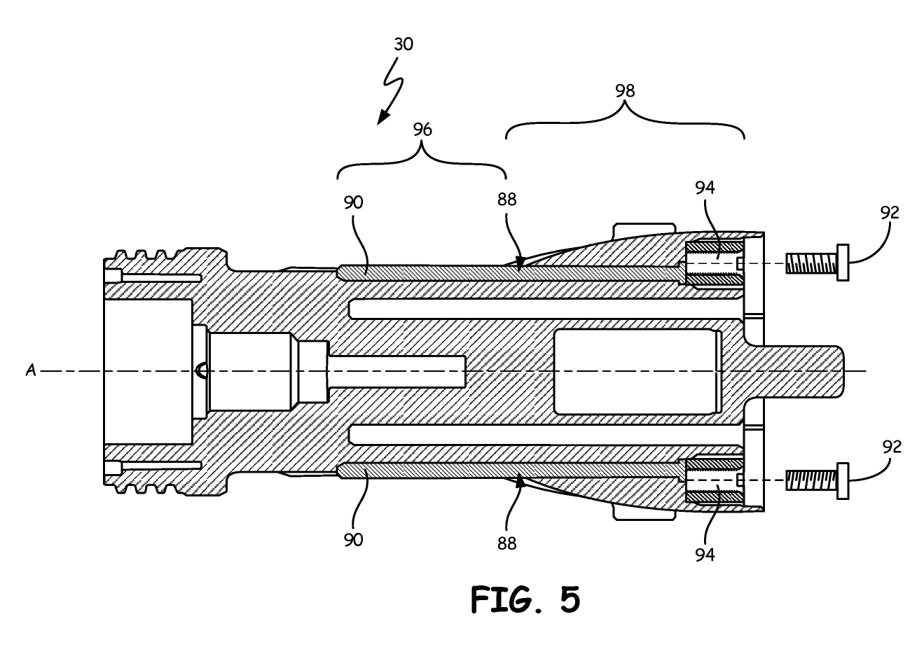

In embodiments of the present invention, an electrostatic spray gun includes grounding rods situated in a gun barrel to provide a shortened ground path for corona discharges from an exposed spray tip electrode. The shortened ground path facilitates higher corona discharges and more efficient spray fluid ionization. FIGS. 1-3 of the present disclosure describe an electrostatic spray gun in which the grounding rods may be used. FIGS. 4 and 5 describe various aspects, embodiments and benefits of the grounding rods.

FIG. 1 is a schematic of electrostatic spray system 10 showing electrostatic spray gun 12 connected to fluid supply 14 and discharging onto target 16. Pump 18 is coupled to fluid supply 14 and provides pressurized fluid to spray gun 12 via hose 20. Spray gun 12 is also connected to a source of pressurized air (not shown) via hose 22. Target 16 is connected to ground, such as by being suspended from rack 24. Electrostatic spray system 10 is described with reference to a fluid spraying system, but other coating materials may be used with the present invention, such as powders and the like. Although FIGS. 1-3 are described with specific reference to an air-assist system, the present invention may also be used with an air-spray system.

Operator 26 positions spray gun 12 in close proximity to target 16, approximately 0.5 meters or less. Upon actuation of a trigger on spray gun 12, pressurized air is supplied to a turbine within spray gun 12 that powers an alternator to generate electrical power. The electrical power is supplied to an electrode near the spray tip of spray gun 12. Thus, electrical field EF is produced between the electrode and target 16. Electrostatic spray system 10 is grounded at various points. For example, ground wire 28 and/or conductive air hose 22 may ground spray gun 12. Other grounding wires and conductive materials may be used throughout electrostatic spray system 10 to provide grounding. Simultaneously, actuation of the trigger allows pressurized fluid from pump 18 through the spray tip whereby atomized particles of the fluid become charged in electrical field EF. The charged particles are thus drawn to target 16, which is grounded. Target 16 is suspended via rack 24 and the electrically charged fluid particles wrap around target 16, thereby significantly reducing overspray.

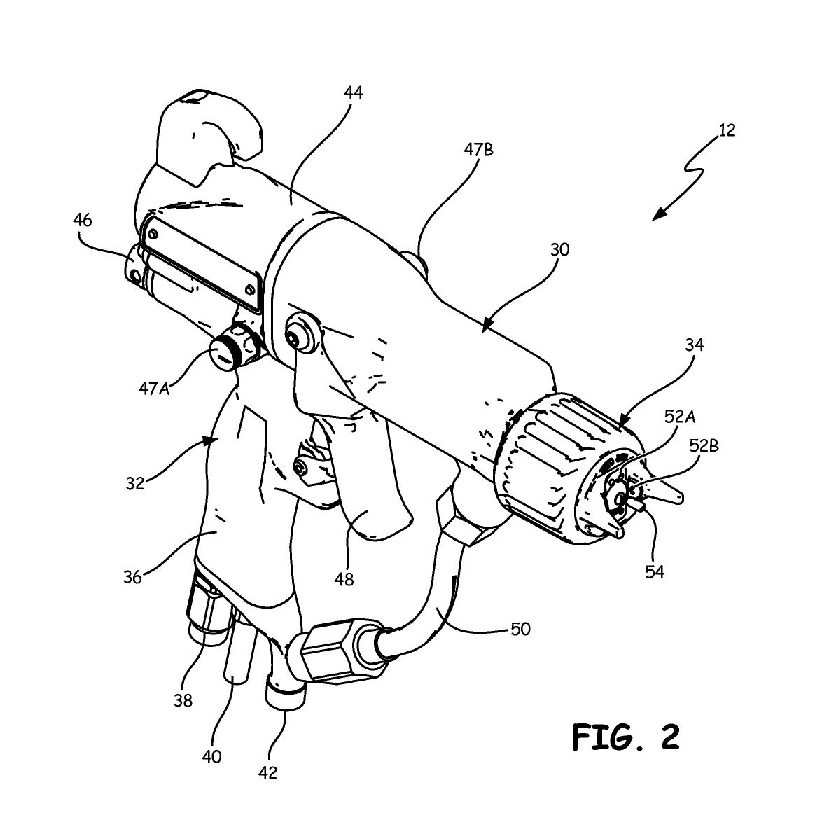

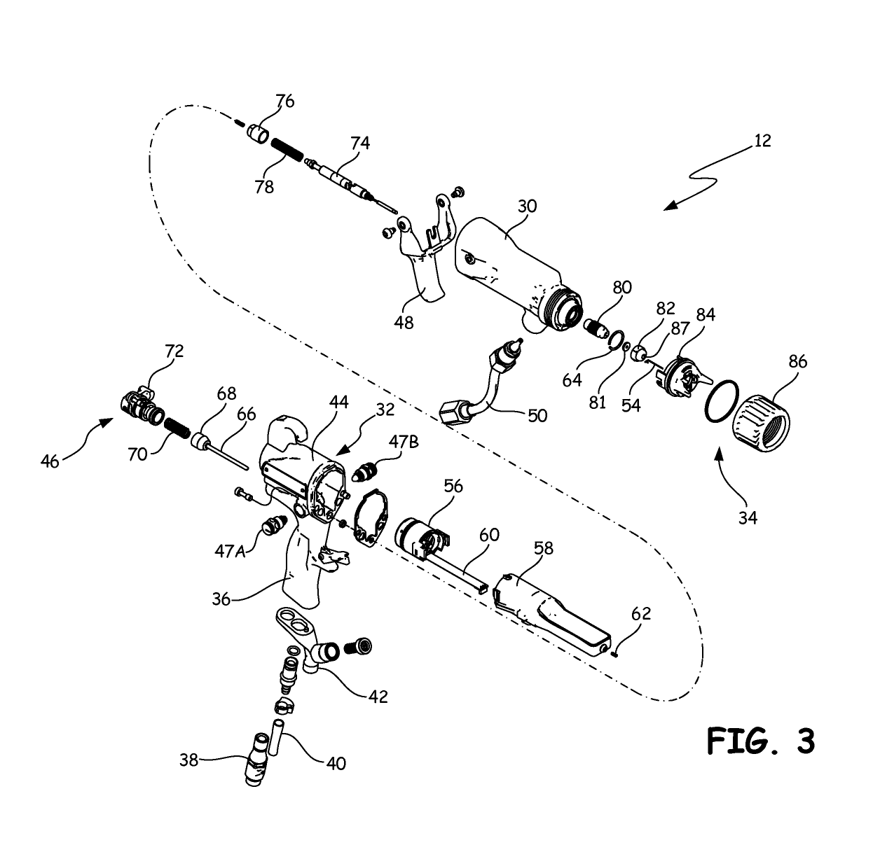

FIG. 2 is a perspective view of electrostatic spray gun 12 of FIG. 1 showing gun barrel 30 connected to handle body 32 and spray tip assembly 34. Handle 36 of handle body 32 is connected to air inlet 38, air exhaust 40 and fluid inlet 42. Housing 44 of handle body 32 is connected to gun barrel 30. Air control 46 is connected to an on/off valve (see air needle 66 in FIG. 3) within housing 44 and controls flow of compressed air from air inlet 38 to the components of spray gun 12. Air adjusters 47A and 47B control the flow of air from the aforementioned on/off valve to spray tip assembly 34. Trigger 48 is connected to a fluid valve (see fluid needle 74 in FIG. 3) within gun barrel 30 and is configured to control flow of pressurized fluid from fluid inlet 42 through spray tip assembly 34 via fluid tube 50. Air control 46 controls the flow of air to the alternator. The air then exits spray gun 12 at exhaust 40.

Actuation of trigger 48 simultaneously allows compressed air and pressurized fluid to spray tip assembly 34. Some of the compressed air is used to influence the flow of fluid from spray tip assembly 34 and thereby exits spray gun 12 at ports 52A and 52B, or other such ports. In air-spray systems, some of the compressed air is also used to directly atomize the fluid as it exits the spray orifice. In both air-spray and air-assist systems, some of the compressed air is also used to rotate an alternator that provides power to electrode 54 and leaves spray gun 12 at exhaust 40. The alternator and an associated power supply for electrode 54 are shown in FIG. 3.

FIG. 3 is an exploded view of electrostatic spray gun 12 of FIG. 2 showing alternator 56 and power supply 58 configured to be located within handle body 32 and gun ban⁻el 30. Alternator 56 is connected to power supply 58 via ribbon cable 60.

Alternator 56 couples to power supply 58 and, when assembled, alternator 56 fits into housing 44 and power supply 58 fits into gun barrel 30. Electricity generated by alternator 56 is transmitted to power supply 58. In air-assist systems, an electric circuit, including spring 62 and conductive ring 64, conveys the electric charge from power supply 58 to electrode 54 inside of spray tip assembly 34. Air-spray systems may have other electric circuits connecting the alternator to the electrode.

Air needle 66 and seal 68 comprise an on/off valve for control of compressed air through spray gun 12. Air control valve 46 includes air needle 66 that extends through housing 44 to trigger 48, which can be actuated to move seal 68 and control flow of compressed air from air inlet 38 through passages within handle body 32. Spring 70 biases seal 68 and trigger 48 to a closed position, while knob 72 may be adjusted to manipulate valve 46. With seal 68 opened, air from inlet 38 flows through the passages within handle body 32 to alternator 56 or spray tip assembly 34.

Fluid needle 74 comprises part of a fluid valve for control of pressurized fluid through spray gun 12. Actuation of trigger 48 also directly moves fluid needle 74, which is coupled to trigger 48 via cap 76. Spring 78 is positioned between cap 76 and trigger 48 to bias needle 74 to a closed position. Needle 74 extends through gun barrel 30 to spray tip assembly 34.

Spray tip assembly 34 includes seat housing 80, gasket 81, tip 82, air cap 84 and retainer ring 86. In air-assist systems, fluid needle 74 engages seat housing 80 to control flow of pressurized fluid from fluid tube 50 through to spray tip assembly 34. Gasket 81 seals between seat housing 80 and tip 82. Tip 82 includes spray orifice 87 that discharges pressurized fluid from seat housing 80. Electrode 54 extends from air cap 84. In air-assist systems, high pressure fluid is fed through spray orifice 87, from which electrode 54 is offset. Atomization occurs by passing the high pressure fluid through a small orifice. In air-spray systems, an electrode extends from a spray orifice such that the electrode and spray orifice are concentric. Low pressure fluid passes through a large spray orifice, and is atomized by impinging airflow from air cap 34. In either systems, air cap 84 includes ports, such as ports 52A and 52B (FIG. 2), that receive pressurized air to atomize and shape the flow of fluid from tip 82 based on setting of adjusters 47A and 47B. In other embodiments, gun 12 may operate without either of ports 52A and 52B, or may operate with only one of ports 52A and 52B.

Operation of alternator 56 under force of pressurized air provides electrical energy to power supply 58 that in turn applies a voltage to electrode 54. Electrode 54 generates electrical field EF (FIG. 1) that applies a charge to atomized fluid originating from tip 82. The Corona effect produced by electrical field EF carries the charged fluid particles to the target intended to be coated with the fluid. Retainer ring 86 maintains air cap 84 and tip 82 assembled with gun barrel 30, while seat housing 80 is threaded into gun barrel 30.

FIG. 4 is a perspective view electrostatic spray gun 12, illustrating gun barrel 30, handle body 32, spray tip assembly 34, handle 36, housing 44, adjuster 47B, trigger 48, fluid tube 50, air cap 84, retainer ring 86, grounding rod 88, rod tip 90, and grounded fastener 92. Gun barrel 30 is a nonconductive body connected at one end to handle body 32 via housing 44, and at an opposite end to spray tip assembly 34. Handle body 32 includes handle 36, which receives air and fluid via air inlet 38 and fluid inlet 42, respectively (see FIGS. 2 and 3). Electrostatic spray gun 12 is grounded at housing 44 to protect against sparking hazards, and ensure the safety of operator 26. In some embodiments, housing 44 may be grounded through wire 28 and/or air hose 22 (see FIG. 1). In general, wire 28 or a similar electrical connection to a ground location runs to handle 36 or another conductive location of spray gun 12, and thereby grounds electrostatic spray gun 12. Housing 44 is a conductive element, and may be grounded via a conductive line in or around hose 20 or air hose 22. In other embodiments, hose 20 and/or air hose 22 may themselves be formed of conductive material, and may ground housing 44 without need for a separate conductive line.

Electrode 54 protrudes from air cap 84 of spray tip assembly 34. Electrode 54 is kept at a high voltage to develop a corona discharge between spray tip assembly 34 and nearby ground surfaces. This corona discharge ionizes atomized fluid particulates, which accordingly deflect electromagnetically to wrap around target 16. A stronger corona discharge in the vicinity of spray tip assembly 34 increases the efficiency of atomized fluid ionization, thereby improving spray efficiency and allowing drawing of fluid to hard-to-reach parts of target 16. The strength of corona discharge current produced at electrode 54 is inversely proportional to resistance along the current path to a proximate ground location. Ground locations near electrode 54 include housing 44 and target 16 (FIG. 1). In general, the resistance of a current path from electrode 54 to either of these ground locations is proportional to the air distance between electrode 54 and the ground location. The shorter this distance, the stronger the resulting corona discharge for a given voltage, and the more efficient the resulting ionization of fluid particles.

Although only one grounding rod 88 is shown in FIG. 4, multiple grounding rods may be disposed on opposite lateral sides of gun barrel 30 (see FIG. 5). Grounding rods 88 are conductive posts embedded in gun barrel 30, and extend from housing 44 through gun barrel 30 towards spray tip assembly 34. Grounding rods 88 are secured to housing 44 by grounded fasteners 92, which also serve to form an electrical connection between grounding rods 88 and housing 44. Grounded fasteners 92 may, for instance, be conductive pins, screws, bolts, or the like. Grounding rods 88 terminate near spray tip assembly 34 at rod tips 90, which may, for instance, be hemispherical in shape.

Grounding rods 88, and particularly rod tips 90, provide a ground location nearer to electrode 54 than housing 44 (which is separated from electrode by the full length of gun barrel 30, which is nonconductive) or target 16 (which is typically kept ˜0.5 m away from spray tip assembly 34). In some embodiments, grounding rods 88 may be situated less than 4 inches from electrode 54. In further embodiments, grounding rods 88 may be situated less than 3 inches from electrode 54. Grounding rods 88 accordingly draw increased corona discharges from electrode 54, improving ionization efficiency. The corona discharge drawn by grounding rods 88 tends qualitatively to wrap around spray tip assembly 34 from electrode 54 to rod tips 90.

FIG. 5 is a cross-sectional view of the gun barrel of the electrostatic spray gun 12, illustrating gun barrel 30, grounding rods 88, rod tips 90, grounded fasteners 92, rod anchors 94, exposed portions 96, and embedded portions 98. Grounding rods 88 pass through gun barrel 30, and are exposed outside of gun barrel 30 only in exposed portions 96, which include rod tips 90. In the depicted embodiment, grounding rods 88 are exposed at exposed portions 96 to provide a clear air path for corona discharge from electrode 54.

Embedded portions 98 are situated within gun barrel 30, and serve to anchor grounding rods 88 in electrostatic spray gun 12. Embedded portions 98 include rod anchors 94, which are hollow sections of grounding rods 88 disposed to receive grounded fasteners 92. Rod anchors 94 have threading or other appropriate geometry to retain grounded fasteners 92, and may, in some embodiments, directly abut housing 44. Grounded fasteners 92 and rod anchors 94 provide a ground path from rod tips 90 to housing 44, which, as discussed above, is grounded e.g. via wire 28 or air hose 22 from handle 36. In the depicted embodiment, gun barrel 30, grounding rods 88, and grounded fasteners 92 are all aligned parallel to a common spray axis A parallel to electrode 54, and grounding rods 88 lie substantially in the same axial plane as spray tip 82 (see FIG. 3). In alternative embodiments, however, grounding rods and grounded fasteners 92 may be oriented at an angle relative to axis A through gun barrel 30.

By providing a shortened ground path for corona discharges from electrode 54, grounding rods 88 increase the strength of corona discharge currents, and accordingly the ionization efficiency of electrostatic spray gun 12. Grounding rods 88 thus improve spray efficiency and wrapping of fluid particulates about target 16 without the need for higher voltage.

Although the present invention has been described with reference to preferred embodiments, workers skilled in the art will recognize that changes may be made in form and detail without departing from the spirit and scope of the invention.

1. An electrostatic spray gun comprises:
a gun barrel;
a housing attached to the gun barrel;
a spray tip assembly attached to the gun barrel opposite the housing, and including an electrode extending away from the gun ban⁻el; and
a first grounding rod electrically connected to the housing but electrically isolated from the spray tip assembly, the first grounding rod extending along the gun barrel from the housing towards the spray tip assembly.

2. The electrostatic spray gun of claim 1, wherein the gun barrel extends substantially along a spray axis parallel to the electrode, and wherein the first grounding rod is substantially parallel to the spray axis.

3. The electrostatic spray gun of claim 1, further comprising a second grounding rod parallel to the first grounding rod, electrically connected to the housing but electrically separated from the spray tip assembly, and extending along the gun barrel from the housing towards the spray tip assembly.

4. The electrostatic spray gun of claim 3, wherein the first and second grounding rods are secured within opposite lateral sides of the gun barrel.

5. The electrostatic spray gun of claim 4, wherein the grounding rods are secured to the housing via conductive fasteners.

6. The electrostatic spray gun of claim 1, wherein the housing is grounded.

7. The electrostatic spray gun of claim 6, further comprising a handle affixed to the housing, and wherein the handle provides a ground path to the housing.

8. The electrostatic spray gun of claim 7, further comprising a ground wire or other conductive means connecting the handle to a ground location.

9. The electrostatic spray gun of claim 1, wherein the electrode and the first grounding rod are separated by a distance of less than 4 inches.

10. The electrostatic spray gun of claim 9, wherein the electrode and the first grounding rod are separated by a distance of less than 3 inches.

11. The electrostatic spray gun of claim 1, wherein the first grounding rod terminates in a hemispherical rod tip nearest the electrode.

12. The electrostatic spray gun of claim 1, wherein the first grounding rod is at least partially embedded within the gun barrel.

13. The electrostatic spray gun of claim 12, wherein the first grounding rod is partially exposed from the gun barrel.

14. The electrostatic spray gun of claim 13, wherein the first grounding rod is embedded within the gun barrel at a first end nearest a grounded housing, and exposed from the gun barrel at a second end nearest the electrode.

15. The electrostatic spray gun of claim 14, wherein the handle is grounded via a wire or other conductive means on an air hose.

16. The electrostatic spray gun of claim 1, further comprising an alternator and a power supply disposed to supply voltage to the electrode.

17. The electrostatic spray gun of claim 16, wherein the alternator is driven by an air-powered turbine.

18. The electrostatic spray gun of claim 17, further comprising an air inlet disposed to supply pressurized air to both the air-powered turbine and the spray tip assembly.
